(19) United States
(12) Patent Application Publication
(10) Pub. No.: US 2008/0310268 A1
(43) Pub. Date: Dec. 18, 2008

(54) POWER CONTROL SYSTEM AND METHOD OF OPTICAL DISK DRIVE

(75) Inventor: Yao-lung Chuang, San-Chung City (TW)

Correspondence Address: MADSON & AUSTIN, 15 WEST SOUTH TEMPLE, SUITE 900, SALT LAKE CITY, UT, 84101, US

(73) Assignee: MEDIATEK Inc., Hsin-Chu (TW)

(21) Appl. No.: 11/762,571

(22) Filed: Jun. 13, 2007

(51) Int. Cl. G11B 7/00

(52) U.S. Cl. 369/47.52

(57) ABSTRACT

The present invention provides a power control system and a method which are capable of generating an optimized output power of the optical disk drive under a variation of operational environment. The power control system comprises a photo detecting unit and a laser emitting unit, two sample-and-hold circuits, two amplifiers, a power control unit, and a digital-to-analog converter. The sample-and-hold circuits and the amplifiers construct a power signal circuit for generating the reading or writing power signals to drive the laser driver. The photo detecting unit detects current laser power and generates a feedback signal. The power control unit is adapted to define a power to feedback signal transfer function and a power-to-DAC transfer function according a relationship between the laser power, the feedback signal and the DAC value. The power control unit transmits a compensating signal to the digital-to-analog converter for compensating the variation of laser power under a temperature variation. The method of the present invention is adapted to define the power to feedback signal transfer function and the power-to-DAC transfer function according the relationship between the laser power, the feedback signal and the DAC value. The compensating signal can be obtained from the power to feedback signal transfer function and the power-to-DAC transfer function for adjusting the total output power of the laser diode of the optical disk drive in order to maintain the output power of the laser diode in a stable state. Therefore, the recording performance of the optical disk drive can be improved by an optimized writing power of the laser emitting unit.

### FIELD OF THE INVENTION

The present invention generally relates to a power control system and a method of same for controlling an optical disk drive, which are capable of generating an optimized output power of the optical disk drive under a variation of operational environment.

### BACKGROUND OF THE INVENTION

In the power control of an optical disk drive during a high-speed recording procedure, a single level of power waveform often causes a bad formation of the pits (or marks) on a recordable disk. As a result, conventional optical disk drive introduces a power control of composite waveform for increasing the writing performance, such as an over-drive power control to a CD-R media or a multi-pulse power control to a CD-RW media.

Referring to FIGS. 1 and 2, which are timing diagrams of two automatic power control (APC) methods of a single-pulse type and a multi-pulse type respectively. In FIG. 1, a resultant power waveform is obtained by superposing an over-drive power waveform to a main power waveform. In FIG. 2, a multi-pulse power signal is generated by synthesizing an erasing sample-and-hold pulse of an erasing power and a writing sample-and-hold pulse of a writing power. The over-drive power signal or the multi-pulse power signal is implemented either by a high-speed sample-and-hold circuit or a peak/bottom hold circuit. However, the period for sampling a feedback signal of laser power is very short because the frequency of the over-drive power signal or multi-pulse power signal is very high in a high-speed recording condition. Hence, the sampled feedback signal is likely to be incorrect if the sampling rate for the laser power feedback signal is not high enough. Further, the laser power control will be unstable or incorrect if it suffers from high-frequency noises when being sampled.

The high frequency of the over-drive power signal or the multi-pulse power signal brings a high error rate of sampling. Because the frequency of the over-drive power signal or the multi-pulse power signal are very high, the over-drive power signal or the multi-pulse power signal are not easy sampled accurately. Therefore, the operational environment variations (e.g. temperature variation) are hardly to be correctly detected according to the sampled result of the over-drive power signal or the multi-pulse power signal. Although the higher sampling rate can be achieved by a high-speed sample-and-hold circuit, it induces a higher cost.

Some conventional arts adopt a well-known open DAC (Digital to Analog Converter) control instead of the APC methods of the over-drive power control or the multi-pulse power control. The open DAC control is capable of obtaining an optimized writing power for retaining a certain recording performance of the optical disk drive under a stable temperature. Nevertheless, the optimized writing power cannot be achieved by the open DAC control in such environment because the characteristic of laser power will be varied under an environment of varied temperatures. Therefore, the recording performance of the optical disk drive by open DAC control will be degraded under an environment with varied temperatures.

Although the varied temperatures can be detected by a temperature sensor, the usage of the temperature sensor in the aforementioned power control methods of laser power will increase the cost of the optical disk drive. Further, conventional control methods would be easily invited within incorrect sampling signals when using a high-speed APC circuit in a high-speed recording condition. Also, that will increase the manufacturing cost of the optical disk drive to raise the sampling rate of signals.

### SUMMARY OF THE INVENTION

The primary object of the present invention is to provide a power control system and a method of same for an optical disk drive, wherein the power control system and the method are capable of generating an optimized output power of the optical disk drive under a variation of operational environment.

Another object of the present invention is to provide power control system and a method of same for an optical disk drive, which generating an optimized output power according to a predetermined relationship between a laser power and a DAC value to overcome the variation of temperatures.

The power control system of the present invention comprises a photo detecting unit and a laser emitting unit, two sample-and-hold circuits, two amplifiers, a power control unit, and a digital-to-analog converter. The sample-and-hold circuits and the amplifiers construct a power signal circuit for generating the reading or writing power signals to drive the laser driver. The photo detecting unit detects current laser power and generates a feedback signal. The power control unit is adapted to define a power to feedback signal transfer function and a power-to-DAC transfer function according a relationship between the laser power, the feedback signal and the DAC value. The power control unit transmits a compensating signal to the digital-to-analog converter for generating a compensating writing power signal to compensate the variation of laser power under an environment variation, e.g. a temperature variation.

The method of the present invention is adapted to define the power to feedback signal transfer function and the power-to-DAC transfer function according the relationship between the laser power, the feedback signal and the DAC value. The compensating signal can be obtained from the power to feedback signal transfer function and the power-to-DAC transfer function for adjusting the total output power of the laser diode of the optical disk drive in order to maintain the output power of the laser diode in a stable state. Therefore, the recording performance of the optical disk drive can be improved by an optimized writing power of the laser emitting unit.

According to the present invention, a compensating signal is generated to adjust the output power of the laser emitting of an optical disk drive, especially to adjust a writing power of the laser emitting, for maintaining the writing power in a stable state. Consequently, the present invention provides a high recording performance of the optical disk drive with a reduced cost by compensating the power variation due to the temperature variation without a high-speed APC circuit.

### BRIEF DESCRIPTION OF THE DRAWINGS

FIGS. 1 and 2 show two conventional power control waveforms of the optical disk drive.

FIG. 3 shows a diagram of a characteristic relationship of the writing DAC value relative to the writing power.

FIG. 4 illustrates a diagram of two characteristic relationships of the DAC value relative to the laser power in different temperatures.

FIG. 5 illustrates a schematic diagram of a simplified structure of the optical disk drive in accordance with the present invention.

FIG. 6 shows an analog implementation of the structure in FIG. 5.

FIG. 7 illustrates a flow chart of a method for obtaining a power-to-DAC transfer function according to the present invention.

FIG. 8 illustrates a flow chart of a method for obtaining a proper power of the laser driver under environment variations based on the power-to-DAC transfer function.

FIG. 9 illustrates another embodiment of the method for obtaining a power-to-DAC transfer function and a power-to-FPDO transfer function.

FIG. 10 illustrates another embodiment of the method for obtaining a proper power of the laser driver under environment variations based on the power-to-DAC transfer function and the power-to-FPDO transfer function.

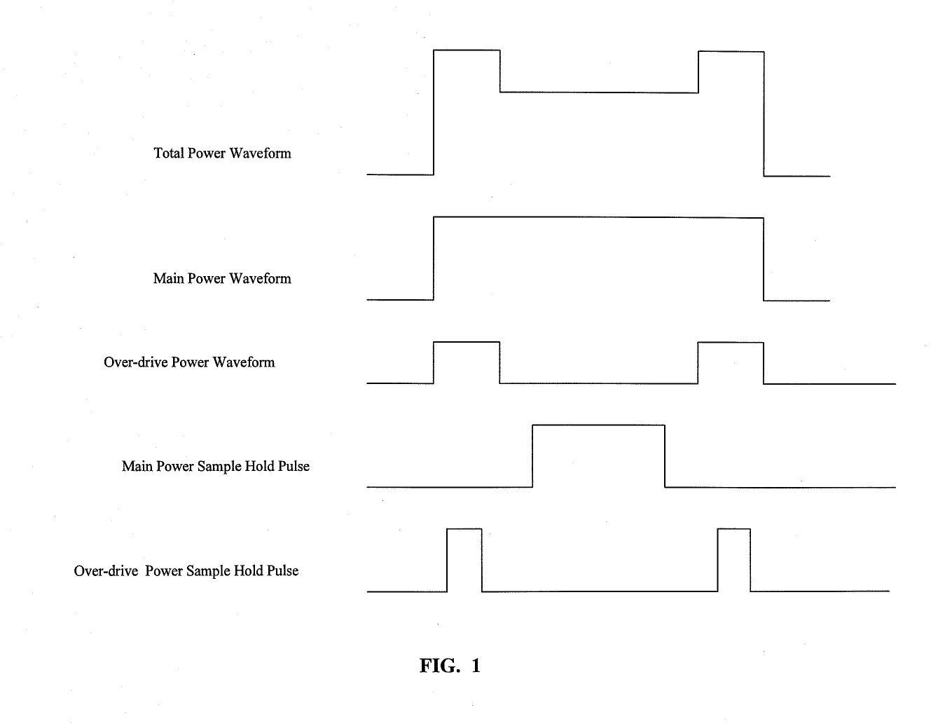

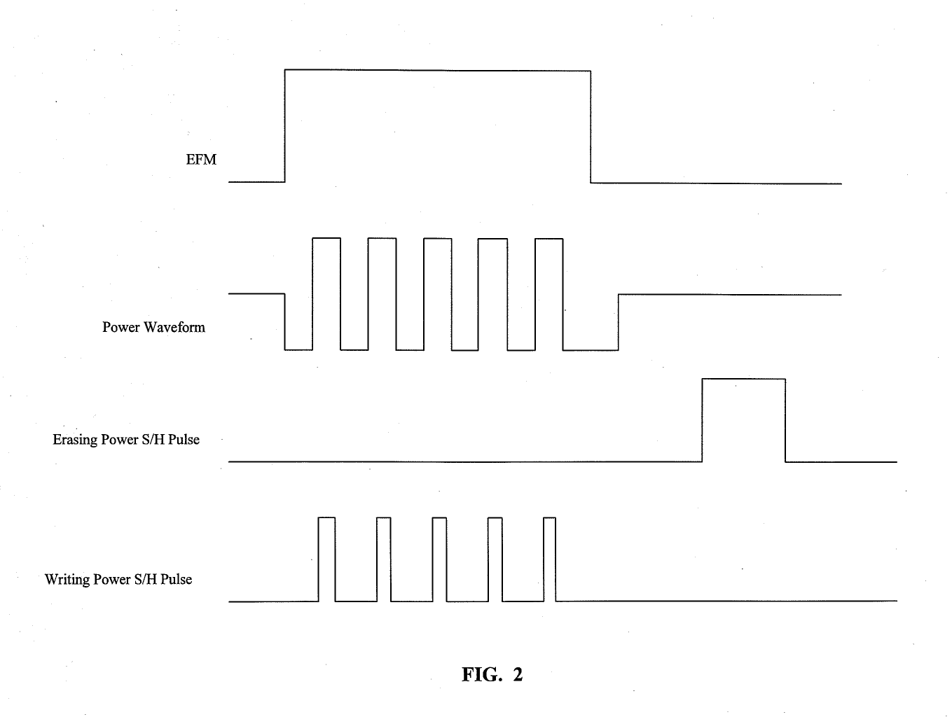

### DETAILED DESCRIPTION OF THE PREFERRED EMBODIMENTS

The present invention is directed to a power control system and a method capable of generating an optimized laser power of an optical disk drive. A general laser power control commonly comprises a power calibration procedure. The power calibration procedure will record a characteristic relationship between a feedback signal level of laser power and a laser power controlling voltage in a memory. The laser power controlling voltage can be adjusted by the feedback signal of laser power being set according to the characteristic relationship. The characteristic of laser power will be varied when the environment temperature changes. If the feedback signal level is too low, it means that the current laser power controlling voltage cannot provide enough laser power, an APC circuit (not shown) will raise the level of laser power controlling voltage until the feedback signal level achieves a proper level in order to maintain a stable feedback signal level. Thus, the overdrive power or the multi-pulse power can be controlled by the APC circuit without the sample-and-hold circuit or open DAC circuit if the characteristic relationship between the feedback signal level of laser power and the laser power controlling voltage can be recorded during the power calibration procedure. The APC circuit can feedback a read channel signal and a write channel signal for controlling the laser power controlling voltage by the characteristic relationship between the feedback signal level of laser power and the laser power controlling voltage, then a compensating controlling voltage can be calculated. As a result, the power variation due to the temperature variation is a kind of low frequency response, the power variation due to the temperature variation can be detected and adjusted without a high-speed controlling circuit in the APC circuit. Therefore, the optical disk drive can maintain a high recording performance with a reduced cost.

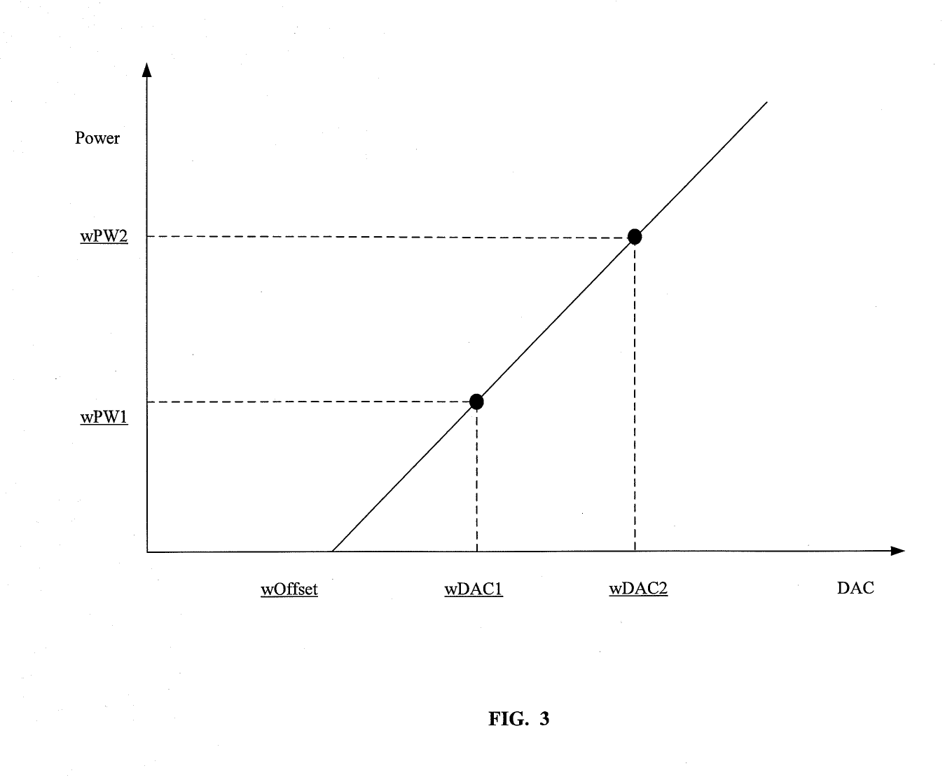

FIG. 3 illustrates a diagram of a characteristic relationship of the writing DAC value relative to the writing power in a specific temperature. Referring to FIG. 3, a first writing power wPW1 is achieved while the writing DAC value is of a first writing DAC value wDAC1. Similarly, a second writing power wPW2 is relative to a second writing DAC value wDAC2. The DAC value is related to a gain of the digital-to-analog converter. Basically, the writing powers are directly proportional to the writing DAC values, i.e. the writing powers are ascendant while the writing DAC values increase. It should be noted that the characteristic relationship of a reading DAC value relative to the reading power is similar to which of the writing DAC value relative to the writing power.

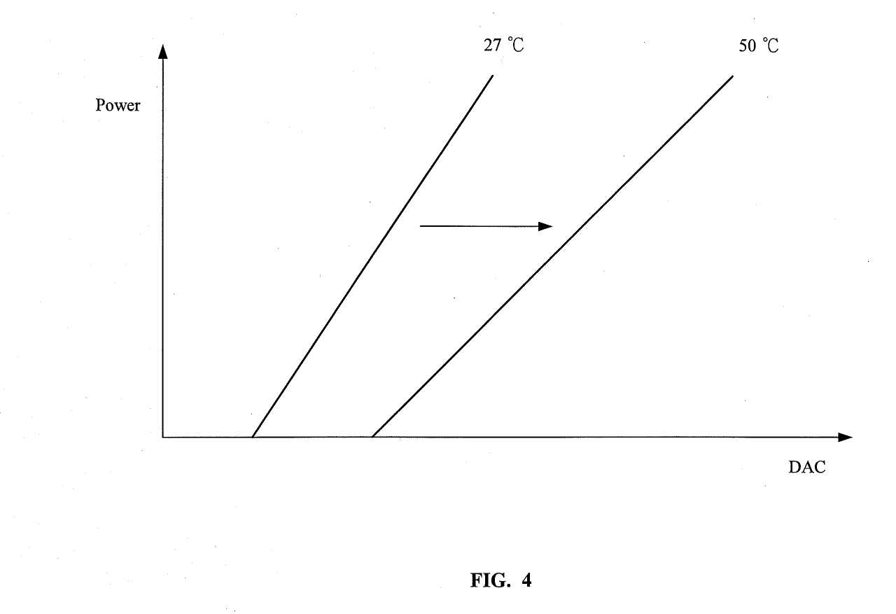

FIG. 4 illustrates a diagram of two characteristic relationships of the DAC value relative to the laser power at different temperatures. Referring to FIG. 4, it is obvious that the two characteristic relationships have different slopes under different temperatures, i.e. the relationship of the DAC value relative to laser power would be varied with the temperature variation. The optical disk drive can adjust the laser power by determining a proper DAC value in accordance with the different characteristic relationships which are stored in the memory.

The characteristic relationship of the DAC value relative to the laser power can be explained clearly by following equations with detailed explanation. Referring to FIG. 3 again, we can set two reference writing DAC values wDAC1 and wDAC2 under a specific temperature for obtaining two corresponding writing power wPw1 and wPw2 respectively. Thus, the equation (1) is obtained to represent the characteristic relationship of DAC value relative to laser power.

$$\frac{Δ wDAC}{Δ wP} = \frac{wDAC 2 - wDAC 1}{wPw 2 - wPw 1} \qquad ( 1 )$$

wherein wDAC represents a writing DAC value of the digital to analog converter, ΔwDAC represents a writing DAC variation of the digital to analog converter, and ΔwP represents a writing power variation of the laser emitting unit.

Then, we can derive the proper reading DAC value wDAC from equation (2).

$$wDAC = \frac{Δ wDAC }{wP} \times wPw + wOffset \qquad ( 2 )$$

wherein wPw represents a current writing power, wOffset represents a writing power offset of the laser emitting unit.

Similarly, the reading DAC value can be derived from the equations (3) and (4).

$$\begin{matrix}\frac{Δ rDAC}{Δ rP} = \frac{rDAC 2 - rDAC 1}{rPw 2 - rPw 1} & ( 2 ) \\ rDAC = \frac{Δ rDAC}{Δ rP} \times rPw + rOffset & ( 4 )\end{matrix}$$

wherein rDAC1 and rDAC2 represent two reference reading DAC values with respect to two reading power rPw1 and rPw2 respectively under a specific temperature, ΔrDAC represents a reading DAC variation of the digital to analog converter, ΔrP represents a reading power variation of the laser emitting unit, rPw represents a current reading power, roffset represents a reading power offsets of the laser emitting unit, rDAC represents a proper reading DAC value of the digital to analog converter.

Further, we can also obtain two output voltage signals VO1 and VO2 of a reading channel of the APC circuit, with respect to the reading powers rPw1 and rPw2 respectively. Accordingly, the characteristic relationship of the output voltage signal relative to the reading power can be explained by the equation (5).

$$\frac{Δ P}{Δ V} = \frac{rPw 2 - rP w 1}{VO 2 - VO 1} \qquad ( 5 )$$

wherein the value of ΔP/A V represents a variation parameter of output power to output voltage of the APC circuit under different temperatures.

We may assume that the output voltage signal of reading channel of the APC circuit is VRO1 at a specific temperature. The characteristic of laser power will be varied by the variation of environment temperatures due to a temperature-rising environment or the high heat capacities produced during the recording operation of the optical dick drive. Therefore, the output voltage signal of APC circuit will be changed to VRO2 in order to maintain a stable output of laser power. Accordingly, we can obtain the characteristic relationship of the variation of the reading power due to the variation of temperatures by comprehending equation (5), shown as equation (6).

$$Δ Pr = ( VRO 2 - VRO 1 ) \times \frac{Δ P}{Δ V} \qquad ( 6 )$$

wherein ΔPr represents the variation of reading power of the laser emitting unit under the temperature variation.

By equation (6), we can introduce a characteristic index 6 under different temperatures to calculate a compensating power ΔPwc for adjusting a writing power of a writing channel of the APC circuit, shown as equation (7).

ΔPwc=δ×ΔPr (7)

Consequently, a compensating DAC value wDACc can be derived by introducing the equation (4) for compensating the output power of the laser emitting unit, shown as equation (8).

$$wDACc = \frac{Δ wDAC}{Δ wP} \times Δ Pwc \qquad ( 8 )$$

Finally, we can obtain the compensating DAC value by realizing the above-mentioned equations to generate a compensating power for maintaining the output power of the laser emitting unit in a stable level. It should be noted that the compensating DAC value can be obtained according to the power values from one of the reading channel and the writing channel or both two channels.

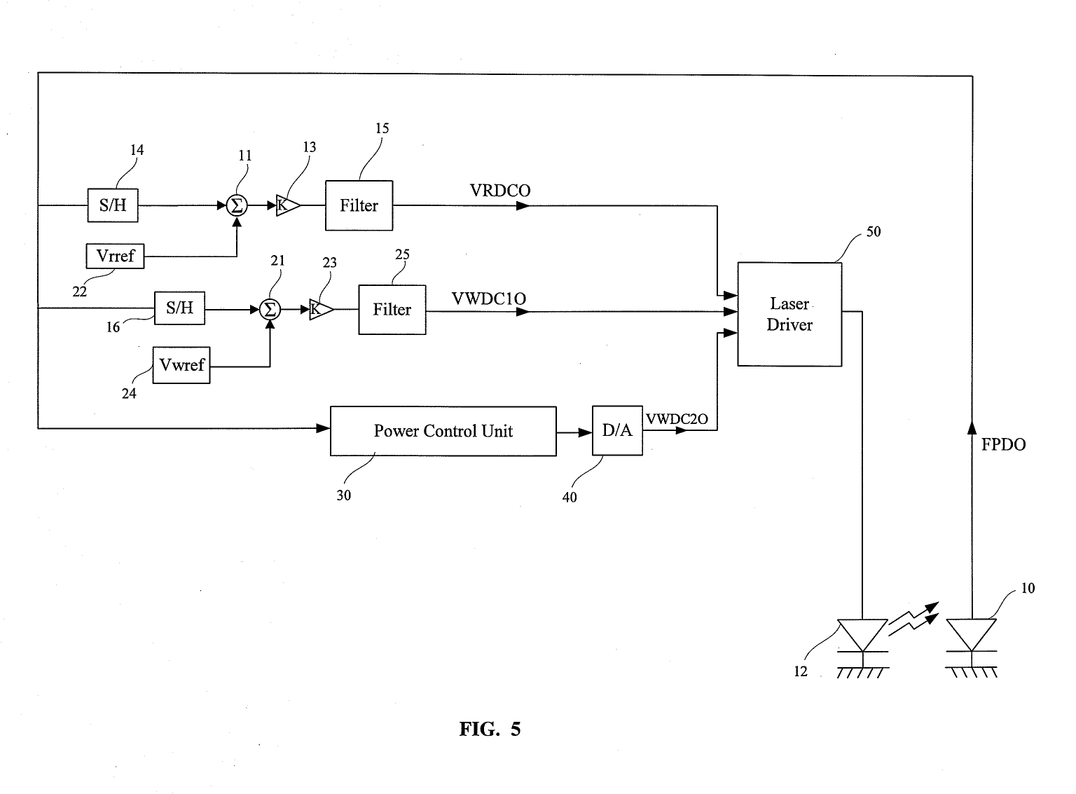

FIG. 5 shows a schematic diagram of a simplified structure of the optical disk drive in accordance with the present invention for generating an optimized laser power. The optical disk drive comprises a pickup-head comprising a photo detecting unit 10 and a laser emitting unit 12, a sample-and-hold circuit 14 for reading power signals, a sample-and-hold circuit 16 for writing power signals, a mixer 11 for reading power signals, a mixer 21 for writing power signals, an amplifier 13 for reading power signals, an amplifier 23 for writing power signals, a filter 15 for reading power signals, a filter 25 for writing power signals, a power control unit 30, a digital-to-analog converter 40 and a laser driver 50 for driving the laser emitting unit 12. The sample-and-hold circuits and the amplifiers construct a power signal circuit for generating the reading or writing power signals to drive the laser driver 50. The photo detecting unit 10 may be a front photo diode (FPD) which detects current reading and writing powers from the laser emitting unit 12 and outputs an FPDO signal to the sample-and-hold circuits 14, 16 respectively for indicating current reading power and writing power. The FPDO is a feedback signal corresponding to the current laser power. The sample-and-hold circuits 14, 16 sample the current FPDO signal then transmit a sampled reading power signal and a sampled writing power signal to the mixers 11, 21 respectively. The mixers 11, 21 mix the sampled reading power signal and sampled writing power signal respectively with a reading reference voltage 22 and a writing reference voltage 24. The mixing results are transitted to the amplifiers 13, 23, respectively. The amplified outputs from the amplifiers 13, 23 are transmitted to the filters 15, 25, respectively. The filters 15, 25 then respectively output an amplified reading power signal VRDCO and an amplified writing power signal VWDC1O to the power control unit 30. The power control unit 30 is adapted to calculate and output a compensating signal according to a predetermined relationship between the laser power and the DAC value. The digital-to-analog converter 40 receives the compensating signal then outputs a compensating writing power signal VWDC2O for compensating the variation of laser power and maintaining laser power in a stable level. The laser driver 50 drives the laser emitting unit 12 by a proper power in accordance with the amplified reading power signal VRDCO, amplified writing power signal VWDC1O and compensating writing power signal VWDC2O respectively.

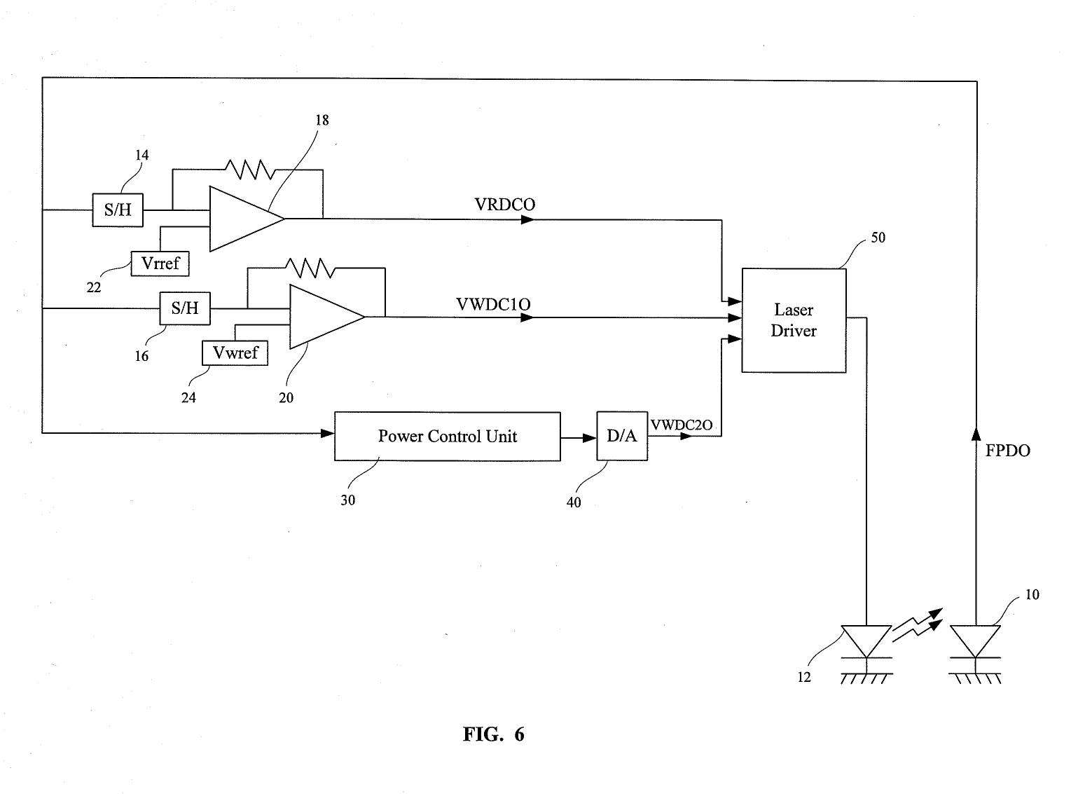

FIG. 6 shows an analog implementation of the structure of FIG. 5. The mixer 11, amplifier 13 and filter 15 for reading power signals are replaced by a differential amplifier 18. The sampled reading power signal from the sample-and-hold circuit 14 and the reading reference voltage Vrref are fed to differential inputs of the amplifier 18, and an amplified reading power signal VRDCO is fed back to the input terminal that the sampled reading power signal is input via a resistor. Similarly, the mixer 21, amplifier 23 and filter 25 for writing power signals are replaced by a differential amplifier 20. The sampled reading power signal from the sample-and-hold circuit 16 and the writing reference voltage Vwref are fed to differential inputs of the amplifier 20, and an amplified reading power signal VWDC1O is fed back to the input terminal that the sampled writing power signal is input via a resistor.

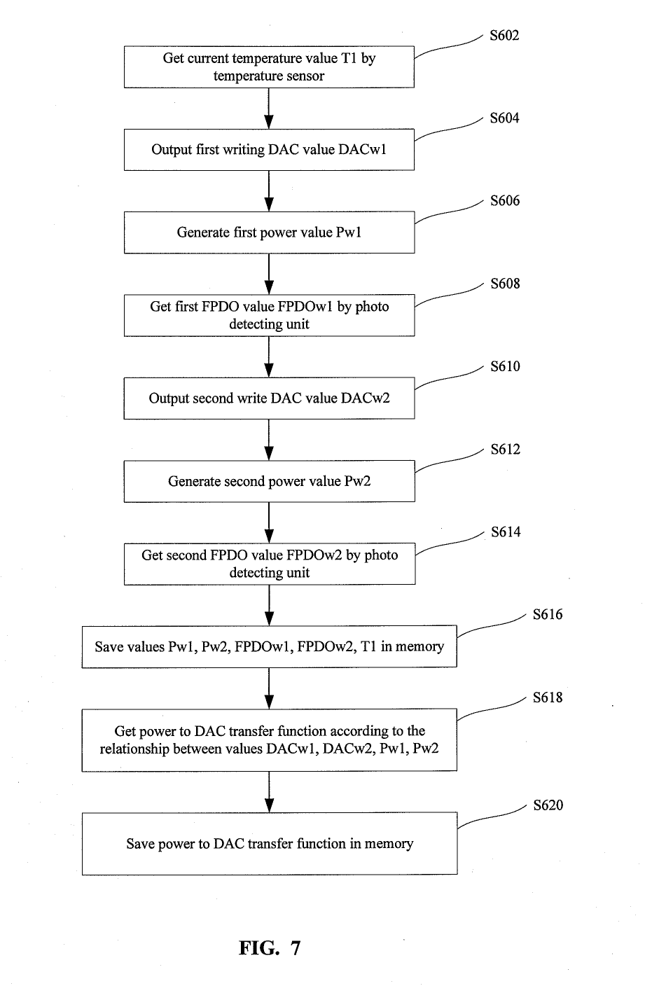

Referring to FIG. 7, a flow chart of a method for obtaining an initial power-to-DAC transfer function is shown. The initial power-to-DAC transfer function is used to generate a proper DAC value for compensating the output power of laser emitting unit according to laser power variation. The method for obtaining the initial power-to-DAC transfer function comprises the steps of:
Step S602 The power control unit 30 receives an initial temperature value T1 sensed by a temperature sensor as a reference temperature.
Step S604 The power control unit 30 outputs a first writing DAC value DACw1 to the digital-to-analog converter 40, then the digital-to-analog converter 40 outputs a first compensating writing power signal to the laser driver 50.
Step S606 The laser driver 50 generates a first power value Pw1 according to the first compensating writing power.
Step S608 The photo detecting unit 10 detects the first power value Pw1 from the laser driver 50 then generates a first FPDO value FPDOw1 corresponding to the first power value Pw1.
Step S610 The power control unit 30 outputs a second writing DAC value DACw2 to the digital-to-analog converter 40, then the digital-to-analog converter 40 outputs a second compensating writing power signal to the laser driver 50.
Step S612 The laser driver 50 generates a second power value Pw2 according to the second compensating writing power.
Step S614 The photo detecting unit 10 detects the second power value Pw2 from the laser driver 50 then generates a second FPDO value FPDOw2 corresponding to the second power value Pw2.
Step S616 The power control unit 30 saves the values of T1, Pw1, Pw2, FPDOw1 and FPDOw2 in a memory.
Step S618 The power control unit 30 defines an initial power-to-DAC transfer function for the reference temperature T1 based on the relationship between the values of DACw1, DACw2, Pw1 and Pw2.
Step S620 The power control unit 30 saves the initial power-to-DAC transfer function for the reference temperature T1 in the memory.

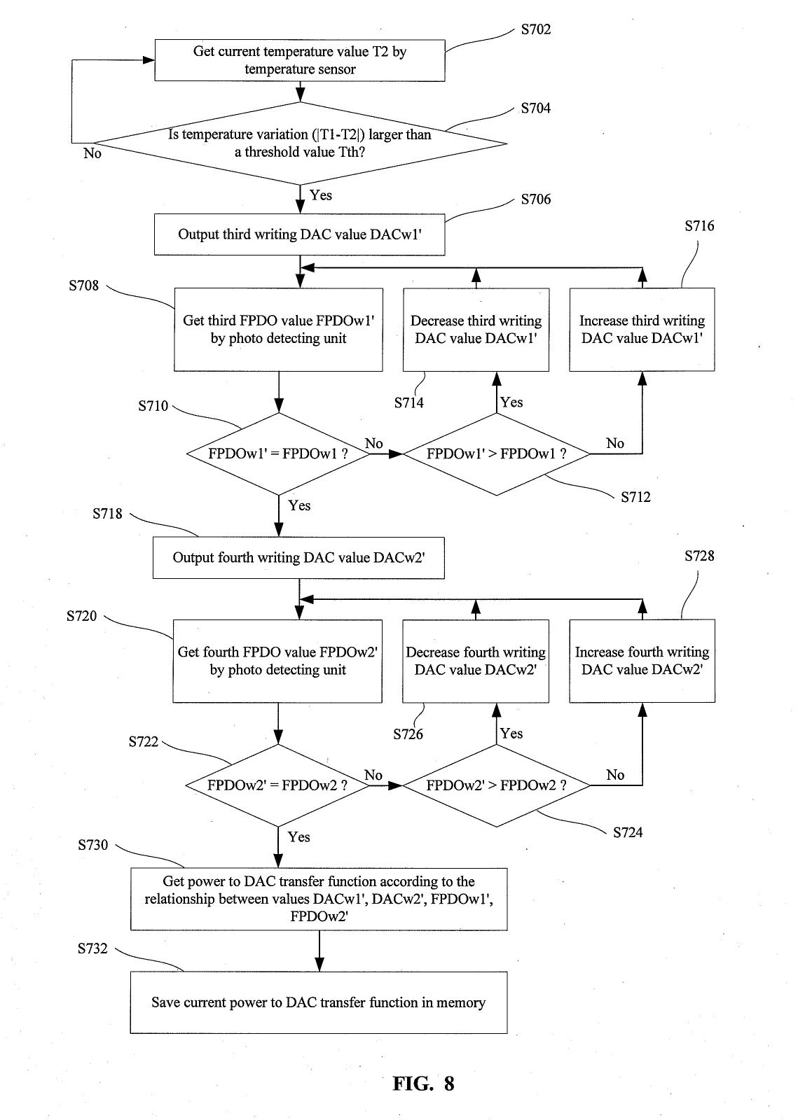

Referring to FIG. 8, a flow chart of a method for obtaining a proper power of the laser driver 50 under environment variations is shown. The proper power of the laser driver 50 can be calculated according to the power-to-DAC transfer function. The method for obtaining a proper power of the laser driver 50 comprises the steps of:
Step S702 The power control unit 30 receives a current temperature value T2 sensed by the temperature sensor;
Step S704 The power control unit 30 compares the temperature value T2 with the reference temperature value T1 for calculating a temperature variation between the temperature values T2 and T1. The method will go to the step S706 if the temperature variation is larger than a predetermined threshold value Tth, otherwise the method goes back to the step S702. It should be noted that the determination of temperature variation can be replaced by a user determination step. The determination condition can be determined by user's demand.
Step S706 The power control unit 30 outputs a third writing DAC value DACw1′ to the digital-to-analog converter 40, then the digital-to-analog converter 40 outputs a third compensating writing power signal to the laser driver 50 for generating a corresponding power.
Step S708 The photo detecting unit 10 detects the power from the laser driver 50 then generates a third FPDO value FPDOw1′ corresponding to the third writing DAC value DACw1′.
Step S710 The power control unit 30 checks whether the third FPDO value FPDOw1′ is equal to the previous first FPDO value FPDOw1. The method will go to the step S718 if the third FPDO value FPDOw1′ is equal to the previous first FPDO value FPDOw1, otherwise the method goes to the step S712.
Step S712 The power control unit 30 checks whether the third FPDO value FPDOw1′ is larger than the previous first FPDO value FPDOw1. The method will go to the step S714 if the third FPDO value FPDOw1′ is larger than the previous first FPDO value FPDOw1, otherwise the method goes to the step S716.
Step S714 The power control unit 30 decreases the third writing DAC value DACw1′. The method goes back to the step S708.
Step S716 The power control unit 30 increases the third writing DAC value DACw1′. The method goes back to the step S708.
Step S718 The power control unit 30 outputs a fourth writing DAC value DACw2′ to the digital-to-analog converter 40, then the digital-to-analog converter 40 outputs a fourth compensating writing power signal to the laser driver 50 for generating a corresponding power.
Step S720 The photo detecting unit 10 detects the power from the laser driver 50 then generates a fourth FPDO value FPDOw2′ corresponding to the fourth writing DAC value DACw2′.
Step S722 The power control unit 30 checks whether the fourth FPDO value FPDOw2′ is equal to the previous second FPDO value FPDOw2. The method will go to the step S730 if the fourth FPDO value FPDOw2′ is equal to the previous second FPDO value FPDOw2, otherwise the method goes to the step S724.
Step S724 The power control unit 30 checks whether the fourth FPDO value FPDOw2′ is larger than the previous second FPDO value FPDOw2. The method will go to the step S726 if the fourth FPDO value FPDOw2′ is larger than the previous second FPDO value FPDOw2, otherwise the method goes to the step S728.
Step S726 The power control unit 30 decreases the fourth writing DAC value DACw2′. The method goes back to the step S720.
Step S728 The power control unit 30 increases the fourth writing DAC value DA Cw2′. The method goes back to the step S720.
Step S730 The power control unit 30 defines a new power-to-DAC transfer function for the current temperature T2 based on the relationship between the values of DACw1′, DACw2′, FPDOw1′ and FPDOw2′.
Step S732 The power control unit 30 saves the new power-to-DAC transfer function in the memory.

The method from the step S702 to step S732 can be used to find the proper DAC value for compensating the output power of laser emitting unit 12 according to the power-to-DAC transfer function. The power variation of laser emitting unit 12 under environment variation can be compensated by the proper DAC value. It should be noted that the power-to-DAC transfer function can be calculated based on more than two sets of the DAC values and the power values. More sets of the DAC values and the power values can be used to obtain a more accurate power-to-DAC transfer function, no matter the power-to-DAC transfer function is linear or non-linear.

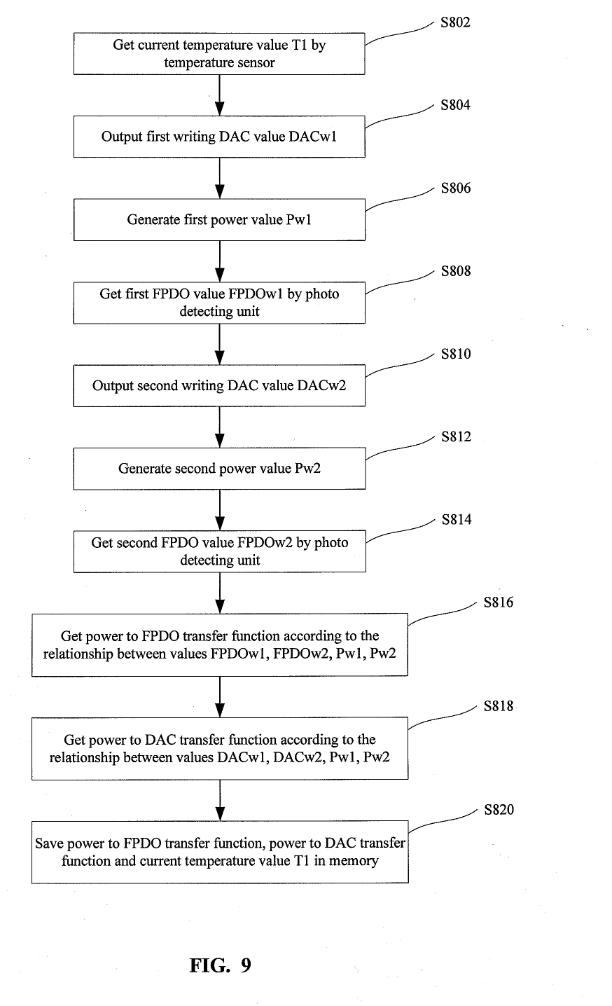

Referring to FIG. 9, another embodiment of the method for obtaining an initial power-to-DAC transfer function and an initial power-to-FPDO transfer function is shown. The initial power-to-DAC transfer function and the initial power-to-FPDO transfer function are used to generate a proper DAC value for compensating the output power of laser emitting unit according to laser power variation. This method comprises the steps of:
Step S802 The power control unit 30 receives an initial temperature value T1 sensed by a temperature sensor as a reference temperature.
Step S804 The power control unit 30 outputs a first writing DAC value DACw1 to the digital-to-analog converter 40, then the digital-to-analog converter 40 outputs a first compensating writing power signal to the laser driver 50.
Step S806 The laser driver 50 generates a first power value Pw1 according to the first compensating writing power.
Step S808 The photo detecting unit 10 detects the first power value Pw1 from the laser driver 50 then generates a first FPDO value FPDOw1 corresponding to the first power value Pw1.
Step S810 The power control unit 30 outputs a second writing DAC value DACw2 to the digital-to-analog converter 40, then the digital-to-analog converter 40 outputs a second compensating writing power signal to the laser driver 50.
Step S812 The laser driver 50 generates a second power value Pw2 according to the second compensating writing power.
Step S814 The photo detecting unit 10 detects the second power value Pw2 from the laser driver 50 then generates a second FPDO value FPDOw2 corresponding to the second power value Pw2.
Step S816 The power control unit 30 defines an initial power-to-FPDO transfer function for the reference temperature T1 based on the relationship between the values of FPDOw1, FPDOw2, Pw1 and Pw2.
Step S818 The power control unit 30 define an initial power-to-DAC transfer function for the reference temperature T1 based on the relationship between the values of DACw1, DACw2, Pw1 and Pw2.
Step S820 The power control unit 30 saves the initial power-to-FPDO transfer function and the initial power-to-DAC transfer function for the reference temperature value T1 in the memory.

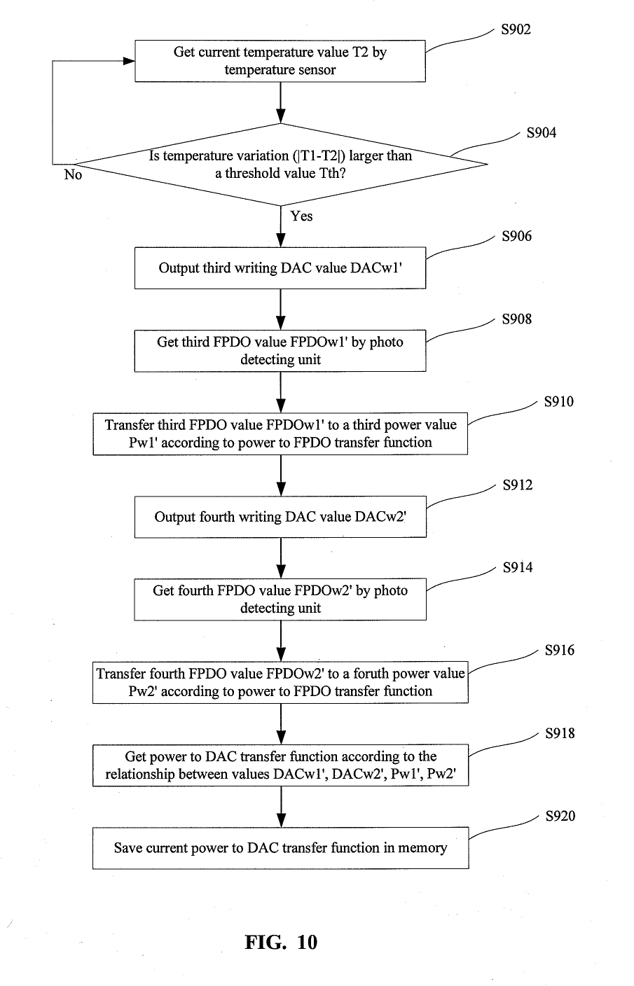

Referring to FIG. 10, another embodiment of the method for obtaining a proper power of the laser driver 50 under environment variations is shown. The proper power of the laser driver 50 can be calculated according to the initial power-to-FPDO transfer function and the power-to-DAC transfer function. This method comprises the steps of:
Step S902 The power control unit 30 receives a current temperature value T2 sensed by the temperature sensor;
Step S904 The power control unit 30 compares the temperature value T2 with the reference temperature value T1 for calculating a temperature variation between the temperature values T2 and T1. The method will go to the step S906 if the temperature variation is larger than a predetermined threshold value Tth, otherwise the method goes back to the step S902.

It should be noted that the determination of temperature variation can be replaced by a user determination step. The determination condition can be determined by user's demand.
Step S906 The power control unit 30 outputs a third writing DAC value DACw1′ to the digital-to-analog converter 40, then the digital-to-analog converter 40 outputs a third compensating writing power signal to the laser driver 50 for generating a corresponding power.
Step S908 The photo detecting unit 10 detects the power from the laser driver 50 then generates a third FPDO value FPDOw1′ corresponding to the third writing DAC value DACw1′.
Step S910 The power control unit 30 transfers the third FPDO value FPDOw1 ‘into a third power value Pw1 ’ according to the initial power-to-FPDO transfer function.
Step S912 The power control unit 30 outputs a fourth writing DAC value DACw2′ to the digital-to-analog converter 40, then the digital-to-analog converter 40 outputs a fourth compensating writing power signal to the laser driver 50 for generating a corresponding power.
Step S914 The photo detecting unit 10 detects the power from the laser driver 50 then generates a fourth FPDO value FPDOw2′ corresponding to the fourth writing DAC value DACw2′.
Step S916 The power control unit 30 transfers the fourth FPDO value FPDOw2′ into a fourth power value Pw2′ according to the initial power-to-FPDO transfer function.
Step S918 The power control unit 30 defines a new power-to-DAC transfer function for current temperature T2 based on the relationship between the values of DACw1′, DACw2′, Pw1′ and Pw2′.
Step S920 The power control unit 30 saves the new power-to-DAC transfer function in the memory.

The method from the step S902 to step S920 can be used to find the proper DAC value for compensating the output power of laser emitting unit 12 according to the initial power-to-FPDO transfer function and the power-to-DAC transfer function. The power variation of laser emitting unit 12 under environment variation can be compensated by the proper DAC value. It should be noted that the power-to-FPDO transfer function and the power-to-DAC transfer function can be defined based on more than two sets of the DAC values and the power values. More sets of the DAC values and the power values can be used to obtain a more accurate power-to-FPDO transfer function or power-to-DAC transfer function, no matter the power-to-DAC transfer function or the power-to-DAC transfer function is linear or non-linear.

By utilizing the above-mentioned embodiments of the present invention, an optimized writing power of the laser emitting unit of the optical disk drive can be determined by introducing the current reading or writing power signals of the laser emitting unit with a predetermined relationship of the output power of the laser emitting unit relative to the DAC value.

According to the present invention, the compensating signal is generated to adjust the output power of the laser emitting of the optical disk drive, especially to adjust the writing power of the laser emitting, for maintaining the writing power in a stable state. Consequently, the present invention provides a high recording performance of the optical disk drive with a reduced cost by compensating the power variation due to the temperature variation without a high-speed APC circuit.

As is understood by a person skilled in the art, the foregoing preferred embodiments of the present invention are illustrative rather than limiting of the present invention. It is intended that they cover various modifications and similar arrangements be included within the spirit and scope of the appendedclaims, the scope of which should be accorded the broadest interpretation so as to encompass all such modifications and similar structure.

What is claimed is:

1. A power control system of generating an optimized output power of an optical disk drive the optical disk drive comprising a photo detecting unit for generating a feedback signal in response to a laser power; and a laser driver for generating the laser power according to a power signal and a control signal, the power control system comprising:
a power signal circuit, outputting the power signal according to the feedback signal from the photo detecting unit; and
a power control unit, detecting the power signal and outputting the control signal according to a relationship between the feedback signal and the laser power for adjusting the laser power.

2. The power control system of claim 1, wherein the relationship between the feedback signal and the laser power is set based on temperature variation.

3. The power control system of claim 2, wherein the relationship contains an index value relative to a specific temperature.

4. The power control system of claim 1, further comprising a digital to analog converter coupled to the power control unit, wherein the digital to analog converter generates a DAC signal to compensate the laser power according to the control signal from the power control unit.

5. The power control system of claim 1, wherein the power signal is related to a writing power signal.

6. The power control system of claim 1, wherein the power signal is related to a reading power signal.

7. A method of generating an optimized output power of an optical disk drive, comprising the steps of:
generating a power signal according to a feedback signal wherein the feedback signal is in response to a laser power;
defining a laser power to power signal transfer function based on a relationship between the power signal and the laser power;
generating a control signal based on the laser power to power signal transfer function by utilizing the feedback signal; and
generating the optimized output power of the optical disk drive according to the control signal.

8. The method of claim 7, further comprising a step of updating the control signal whenever a new control signal is generated.

9. The method of claim 7, before the step of driving a laser driver, further comprising a step of storing the laser power to power signal transfer function in a memory.

10. The method of claim 7, wherein the relationship between the power signal and the laser power is set based on temperature variation.

11. The method of claim 10, wherein the relationship between the power signal and the laser power contains an index value relative to a specific temperature.

12. The method of claim 7, further comprising a step of generating a DAC signal by a digital to analog converter to compensate the laser power according to the control signal from the power control unit.

13. The method of claim 7, wherein the power signal is related to a writing power signal.

14. The method of claim 7, wherein the power signal is related to a reading power signal.

15. A method of generating an optimized output power of an optical disk drive, comprising the steps of:
generating a power signal according to a feedback signal, wherein the feedback signal is in response to a laser power;
defining a laser power to feedback signal transfer function based on a relationship between the feedback signal and the laser power;
defining a laser power to power signal transfer function based on laser power to feedback signal transfer function;
generating a control signal based on the laser power to power signal transfer function by utilizing the feedback signal; and
generating the optimized output power of the optical disk drive according to the control signal.

16. The method of claim 15, further comprising a step of updating the control signal whenever a new control signal is generated.

17. The method of claim 15, before the step of driving a laser driver, further comprising a step of storing the laser power to feedback signal transfer function and the laser power to power signal transfer function in a memory.

18. The method of claim 15, wherein the relationship between the feedback signal and the laser power is set based on temperature variation.

19. The method of claim 18, wherein the relationship between the feedback signal and the laser power contains an index value relative to a specific temperature.

20. The method of claim 15, further comprising a step of generating a DAC signal to compensate the laser power according to the control signal from the power control unit.

21. The method of claim 15, wherein the feedback signal is related to a writing power signal.

22. The method of claim 15, wherein the feedback signal is related to a reading power signal.
